(19) United States
(12) Patent Application Publication
(10) Pub. No.: US 2011/0243096 A1
(43) Pub. Date: Oct. 6, 2011

(54) NETWORK APPARATUS AND METHOD FOR TRANSMITTING A MESSAGE TO A TARGET NETWORK APPARATUS IN THE WIMAX SYSTEM

(75) Inventors: Achim Von Brandt, Munchen (DE); Shun Liang Zhang, Beijing (CN); Yi Zhang, Beijing (CN); Wei Hua Zhou, Beijing (CN)

(73) Assignee: NOKIA SIEMENS NETWORKS OY, Espoo (FI)

(21) Appl. No.: 13/119,665

(22) PCT Filed: Sep. 19, 2008
(86) PCT No.: PCT/EP08/62521

§ 371 Date: Jun. 20, 2011

(51) Int. Cl. H04W 36/00

(52) U.S. Cl. 370/331

(57) ABSTRACT

A network apparatus for transmitting a message to a target network apparatus is described, which may comprise a trigger device, a target profile determining device, a message preparation device and a message transmitting device. The trigger device may be adapted for determining and/or detecting a trigger for transmitting a message. The target profile determining device may be adapted for determining a profile of the target network apparatus. The message preparation device may be adapted for preparing a message for transmitting the message to the target network apparatus in accordance with the determined profile of the target network apparatus. The transmitting device may be adapted for transmitting the prepared message to the target apparatus.

### CROSS REFERENCE TO RELATED APPLICATIONS

This application is a national stage entry of PCT Application No. PCT/EP2008/062521, filed on Sep. 19, 2008, entitled “NETWORK APPARATUS AND METHOD FOR TRANSMITTING A MESSAGE TO A TARGET NETWORK APPARATUS IN THE WIMAX SYSTEM”, the disclosure of which is hereby incorporated by reference in its entirety.

### TECHNICAL FIELD

The present invention relates to the technical field of communication networks. In particular the present invention relates to the technical field of wireless communication networks and to a network apparatus for transmitting a message, to a target network apparatus for indicating capability limitation, to a method for transmitting a message to a target network apparatus, to a method for indicating capability limitation, to a computer-readable medium and to the use of a handover response message for indicating capability limitation.

### BACKGROUND

The document “WiMAX™ Forum Network Architecture, Stage 2: Architecture Tenets, Reference Model and Reference Points), Part 1”, Release 1, Version 1.2, Jan. 11, 2008, WiMAX™ Forum, defines an Access Service Network (ASN) as a complete set of network functions needed to provide radio access to a WiMAX™ subscriber. The ASN provides WiMAX™ Layer-2 (L2) connectivity with the WiMAX™ MS (Mobile Station), transfer of Authentication, Authorization and Accounting (AAA) messages to WiMAX™ subscribers Home Network Service Provider (H-NSP) for authentication, authorization and session accounting for subscriber sessions, network discovery and selection of the WiMAX™ subscribers preferred Network Service Provider (NSP). Furthermore, the ASN provides the relay functionality for establishing Layer-3 (L3) connectivity with a WiMAX™ MS (i.e. IP (Internet Protocol) address allocation) and Radio Resource Management (RRM).

In addition for a portable and mobile environment an ASN shall support ASN anchored mobility, CSN (Connectivity Service Network) anchored mobility, paging and ASN-CSN tunnelling. An ASN comprises network elements such as one or more base station(s) and one or more ASN Gateway(s) (ASN GW). An ASN may be shared by more than one Connectivity Service Networks (CSN).

According to the document of the WiMAX™ Forum, “WiMAX™ Forum Network Architecture, Stage 2: Architecture Tenets, Reference Model and Reference Points [Part 1]”, Release 1, Version 1.2, Jan. 11, 2008 a profile maps ASN functions into BS (Base Station) and ASN-GW (ASN Gateway) so that protocols and messages over the exposed referenced point are identified.

From the document WiMAX™ Forum, “WiMAX™ Forum Network Architecture, (Stage 3: Detailed protocols and procedures), NWG Maintenance Implementation Review Draft”, Release 1, Version 1.2.3, Jul. 25, 2008 ASN profile mappings are known.

In the WiMAX™ network realization and deployment, three profiles are defined: Profile A, B, C. There may be a considerable difference between profile A and profile C. For example, profile A (1) HO (Handover) control may be located in the ASN-GW. (2) RRC (Radio Resource Control) may be located in the ASN-GW that allows RRM among multiple BS.

The features of profile C may comprise (1) HO control may be located in the Base Station (BS) and RRC may be in the BS, which would allow for RRM within the BS. (2) An “RRC relay” may be located in the ASN-GW to relay the RRM messages sent from BS to BS via R6 (Reference point 6).

This may allow setting up homogeneous profile A network infrastructures based on a profile A and homogeneous network infrastructures based on profile C.

However, in some cases coupling and interworking of ASN-GWs based on different profiles may be required. In these cases messages directed from a source to a destination lying in different ASNs based on different profiles may not work.

There may be a need to provide a more efficient coupling of ASNs.

### SUMMARY

According to an exemplary embodiment of the present invention, a network apparatus for transmitting a message to a target network apparatus, a target network apparatus for indicating capability limitation, a method for transmitting a message to a target network apparatus, a method for indicating capability limitation, a computer-readable medium and the use of a handover response message for indicating capability limitation may be provided.

According to a further exemplary embodiment of the present invention, a network apparatus for transmitting a message to a target network apparatus may comprise a trigger device, a target profile determining device, a message preparation device and a message transmitting device.

In an example, the trigger device may be adapted for determining and/or detecting a trigger for transmitting a message. In an example the target profile determining device may be adapted for determining a profile of the target network apparatus. In another example, the message preparation device may be adapted for preparing a message for transmitting the message to the target network apparatus in accordance with the determined profile of the target network apparatus. In a further example, the transmitting device may be adapted for transmitting the prepared message to the target apparatus.

In a further example the target profile determining device may be a target profile determining mechanism.

In another example, a target profile determining device may not be available. In such a case the network apparatus may use the profile or the profile information of the network apparatus and not the profile or the profile information provided by the target network apparatus.

According to another exemplary embodiment of the present invention, a target network apparatus for indicating capability limitation may be provided. The target network apparatus may realize a mismatch of the profile of the target network apparatus and a received message. In an example the target network may detect by comparing the content of at least one field or of at least one parameter of a message with an expected content of the message the mismatch of the profile of the target apparatus and the received message. In another example, a profile information may be provided in a field of the message, indicating the profile of the target network.

The target network apparatus may comprise a receiving device and a transmitting device. In an example the receiving device may be adapted for receiving a message and for detecting an associated profile necessary for handling the message, i.e. determining or detecting, whether the assumed profile indicated by the message and the profile of the target network may differ.

In another example, the transmitting device may be adapted for transmitting a message indicating a capability limitation if the target network may base on a profile, which may differ from the profile necessary for handling the received message.

According to a further exemplary embodiment of the present invention, a method for transmitting a message to a target network apparatus may be provided, wherein the method comprises determining a trigger for transmitting the message.

In another example the method for transmitting a message to a target network may further comprise determining a profile of the target network apparatus and preparing a message for transmitting the message to the target network apparatus in accordance with the determined profile of the target network apparatus. Furthermore, the method may comprise, transmitting the prepared message to the target network apparatus.

According to yet another exemplary embodiment of the present invention, a method for indicating capability limitation may be provided.

The method for indicating capability limitation may comprise receiving a message and detecting an associated profile necessary for handling the message. In an example the method for indicating capability limitation may also comprise transmitting a message indicating capability limitations if the target network may base on a different profile than necessary for handling the received message.

According to another exemplary embodiment of the present invention, a computer-readable medium may be provided. The computer-readable medium may comprise a computer program, which computer program when being executed by a processor may be adapted to carry out at least one method from the method for transmitting a message to a target network apparatus and the method for indicating capability limitation.

According to yet another exemplary embodiment of the present invention, the use of a handover response message for indicating capability limitation.

In particular the handover response message may be used for transmitting capability limitations to a network apparatus. In further examples a HO message, an RRM (Radio Resource Management) message, R4/R6 Spare_Capacity_Rpt (Report) message, R4/R6 Radio_Config_Update_Rpt message may be used.

In another exemplary embodiment of the present invention, a program element may be provided which, when being executed by a processor may be adapted to carry out at least one method from the method for transmitting a message to a target network and the method for indicting capability limitation.

A computer-readable medium may be a floppy disk, a harddisk, a USB (Universal Serial Bus) storage device, a RAM (Random Access Memory), a ROM (Read Only Memory) and an EPROM (Erasable Programmable Read Only Memory). A computer-readable medium may also be a data communication network, e.g. the Internet, which may allow downloading a program code.

As a basic principle, the inter ASN interoperability, i.e. the connection of several ASNs, through reference points R4 may be independent of any particular ASN profile. Thus, messages transmitted via an R4 reference point may be transmitted between different ASN-GWs, independently on what profile the corresponding ASN-GW may base. Therefore, the possibility may exist to connect a network architecture, which may base on a profile A with a network architecture, which may base on a profile C. In other words, connecting a profile A ASN to a profile C ASN may be possible however may not work since the handling of messages which may be used in different profiles may be different. Thus, interworking between ASNs basing on different profiles may not be possible.

For example, multiple target BS info parameter or multiple target BS information, i.e. information for the target BS or for different target BSs, may be included in one R6 or R4 message to save the signalling overhead. In other words, in an example, if a BS or an ASN may transfer information to a plurality of BSs, to a list of BSs or to one or more target BSs a message may comprise a field with one or more target BS info parameter or parameters. A single BS may need to communicate to a plurality of BSs with a single message, when a BS or an ASN-GW may send messages to a plurality of candidates of BSs for a handover or for handing off a mobile station.

In other words, if multiple target BSs may be involved, the multiple target BS info may be included in one single R4/R6 message (R4 message and/or R6 message), on BS info corresponding to one target BS which may be indicated by BS ID.

A profile A ASN, which may control associated RRAs (Radio Resource Agents) may be able receiving a single R6 message or a single R4 message and distributing it to multiple target BSs according to multiple target BS info contained in the message.

In an example as the ASN-GW working as the controller for an ASN during a HO (handover) or during an RRM (Radio Resource Management) process may analyze and may process the incoming R4/R6 messages.

For a profile C ASN, i.e. an ASN, which may base on profile C, the profile C ASN-GW may just act as a relay entity and thus, may transparently forward a received message. During a HO process or a RRM process, all the R4/R6 messages may be transparently relayed from the serving BS to the target BS.

Since the profile C ASN-GW may transparently forward a received message the profile C ASN-GW may not analyze a received message, even if multiple target BS info may be included in a corresponding R4 message/R6 message. Thus, if a profile A ASN and a profile C ASN may be linked together the profile C ASN-GW or the relay may not fan out, fork or extract the several R6 messages and/or R4 messages which may be comprised as a multiple BS info in an R4 message and/or in an R6 message.

Therefore, transparently switching a message may prevent interworking of R4 messages and/or R6 messages with multiple BS info, R4/R6 messages comprising multiple BS info or R4/R6 messages having multiple BS info.

In an example a HO process may be specified for a profile C based ASN and the profile A based ASN independently. A handover process for an inter ASN HO, i.e. a handover or a radio resource management operation between ASNs basing on different profiles may not be specified.

However, combining ASNs, which may base on different profiles, may not allow interworking Furthermore, determining a profile of a target ASN or of a target BS and thus, determining that interworking may not be possible allow preventing that interworking issues may arise or in the case of reactive methods to react to such deficiencies. For example, a serving BS or a serving ASN-GW may determine that a target ASN-GW may be a relay. Thus, the serving BS and/or the serving ASN-GW may detect, that they are the last instance or a border instance before entering an ASN basing on profile C. Thus, serving BS or a serving ASN-GW may be adapted to extract information from a message which may not be interpreted by the relay. In other words, a gateway, which may connect a profile A ASN and a profile C ASN may fan out information from a single R4/R6 message and may prepare individual messages for each target BS info comprised in a corresponding single message.

In another example, a source address may be amended such, that the target for the message may believe that the message has been sent from the controller belonging to the corresponding target. For example, the T ASN-GW of a profile A ASN may always be seen as a responsible controller for T-BSs connected to the T-ASN to the profile A T-ASN (target ASN).

A trigger for starting sending a message to a target network apparatus may be a signal indicating that a handover shall take place. A handover trigger signal may be generated by an MS, by a SBS and may be detected by the S-BS or by an S-ASN. A trigger may be also receiving an indication for conducting RRM operations.

After detecting that the target may base on a different profile than the serving ASN, allow to prepare or to convert the message such, that the message may be handled in the target ASN as if the message would have been sent by an S-BS or an S-ASN-GW basing on the same profile than the target. Depending on the determined profile different measurements have to be conducted in order to adapt a message to the target profile. For example, different measurements may have to be conducted sending a message from an ASN basing on a profile A to an ASN basing on the profile C and from an ASN basing on profile C to an ASN basing on profile A.

Detecting of the target profile may also comprise sending an investigation message to the target network and receiving an error message or a message comprising the target profile.

This information about the target profile may be stored, in order to access the information later.

According to a further exemplary embodiment of the present invention, determining the profile of the target network apparatus may comprise retrieving information about the target profile stored in the target profile determining device and/or retrieving information about the target profile by transmitting a message in accordance with the profile of the network apparatus.

In an inter-ASN scenario, i.e. if ASN of different network profiles may be coupled together for interworking purposes, the network apparatus may be from one ASN profile and the target network apparatus may be from another ASN profile.

However, the network apparatus may do not know the profile of the target network apparatus. In such a case, the network apparatus may retrieve the information about the target profile by sending a message to the target network apparatus assuming that the target network may have the same profile as the network apparatus.

If the target network apparatus may not have the same profile as the network apparatus, the target network apparatus may send the profile or the profile information of the target network apparatus to the network apparatus. The network apparatus may locally store the retrieved information about the profile of the target network apparatus. Thus, a learning function may be implemented.

Once the profile information may have been stored, the network apparatus may retrieve information about the target profile, the profile of the target network apparatus or the profile of the target ASN by accessing a local storage, which may be implemented in the target profile determining device.

Accessing a local storage for retrieving information about a profile of a target network may save time for transmitting a message in accordance with the profile of the network apparatus and may prevent receiving an error indication comprising the profile information of the target network apparatus. In other words, storing the profile information of the target ASN may prevent exploring for the profile information in the remote target ASN.

Sending a message, which may not be in accordance with the target network apparatus or with a profile of the target network apparatus may lead to receiving an error indication from the corresponding target network apparatus

According to a further exemplary embodiment of the present invention, the message preparation device may be adapted for determining the destination for the prepared message by deriving a HO Function location.

Knowing the location of the HO Function may help transmitting the message to the target network apparatus in accordance with a correct profile of the target network apparatus.

In an example in a profile C ASN, the HO Function may be located in a base station. Thus, having knowledge about the location may allow sending a message directly to the base station of the target ASN, which base station may be the target network apparatus. Thus, sending a message to a target network apparatus, whose HO Function may be located in a base station, may require transmitting the message to the base station. Thus, if a message may comprise a plurality of target BS info values, a plurality of target BS info parameter or if an input message may comprise a plurality of target BS info parameter, the network element (serving ASN GW) may fork the message into several output messages, wherein each output message may be directed to one separate target BS, and only one single BS info parameter of the plurality of target BS info parameter of the input message may be included in each of the output messages.

In another example in a profile A ASN, the HO Function may be located in an ASN GW. Thus, having knowledge about the location of the HO function may allow sending a message directly to the ASN GW of the target ASN, which ASN GW may be the target network apparatus. Thus, sending a message to a target network apparatus, whose HO Function may be located in an ASN GW, may require transmitting the message to the ASN GW.

According to another exemplary embodiment of the present invention, the message may comprise multiple target BSs.

Including multiple target BSs, a plurality of target BSs, multiple target BS info, multiple target BS info parameter or one or more T-BS info in a single message may allow saving signalling overhead. In an example, a multiple target BS may be a multiple target BS information or a multiple target BS info TLV value (Type, Length, Value). The BS info parameter or BS info TLV may comprise the related info of the same target BS.

According to another exemplary embodiment of the present invention, the network apparatus may be at least one network apparatus selected from the group consisting of an Access Service Network gateway (ASN-GW), a profile A ASN-GW, a profile C ASN-GW, a Base Station, a Serving Base Station (S-BS), a Target Base Station (T-BS) and a profile C Base Station. The network apparatus may also be adapted to receive a failure indication or an error indication in order to determine a profile of a target network.

In an example the message may comprise a list of one or more target BS or a list of one or more BS info.

According to another exemplary embodiment of the present invention, the profile determining device may be adapted to determine the profile of the target network by at least one method selected from the group of methods consisting of receiving the profile from the target network apparatus, receiving the profile from a central server, receiving the profile from a static configuration, receiving the profile from a dynamic learning, receiving a Handover Function location (HO Func location) derived from a profile type from a static configuration and receiving a capability limitation message from a target network apparatus. Furthermore, the network apparatus may store a detected profile in a storage, which the network apparatus comprises.

In an example, the profile may be a profile info or a profile information.

Different methods for retrieving the profile information about on which profile a target network apparatus may base, may provide a high flexibility in how to retrieve the information about the profile of a target network apparatus.

The profile or the location of HO function, which HO function may be derived from profile type of the target ASN, may be reported to the ASN GW of profile A or to the profile A ASN GW. The network apparatus may be the profile A ASN GW. Thus, the profile determining device may also be adapted to derive the location of the HO function.

The profile or the location of the HO function, which HO function may be derived from a profile type of the target BS, may be reported to the BS of profile C or to the profile C BS. The network apparatus may be the profile C BS. Thus, the profile determining device may also be adapted to derive the location of the BS by determining the HO Func location.

The ASN GW of profile A may be able to send out R4 HO messages according to the profile type of the target ASN. In case the profile of the target ASN may be profile C, the ASN GW may send a dedicated R4 HO message to each target BS.

The ASN GW of profile A alternatively may send a HO message to the entity, to the location or to the unit, to the device or to the apparatus in the target ASN, which entity may be indicated by HO function location. The HO function location may be derived from the profile info. Thus, a network apparatus may store the location where a corresponding message may be allowed to be sent to. The ASN GW of profile A and the HO Function location may be collocated.

The BS of profile C may be able to send out R6 HO messages according to the profile of the target BS. In a case where the profile of target BS may be profile A, the BS may send an R6 HO message to the target ASN GW associated (connected with R6) with the target BS, where the HO function is located. The HO function may be located in the ASN GW. The message may be relayed by the serving ASN GW to the target ASN GW.

The BS of profile C may send a HO message to the entity, to the location or to the unit, to the device or to the apparatus in the target ASN, which entity may be indicated by the HO function location. The BS of profile C and the HO Function location may be collocated.

According to another exemplary embodiment of the present invention, the message preparation device may be adapted to fan out a message to the target network apparatus. Fanning out or extracting a message may mean, forking an input message to several output messages, each output message directed to one separate target entity.

Thus, information included in the message may be extracted, or forked into several individual messages. Such extracting may allow sending a message to a plurality of a target.

In an example, the network apparatus in the serving ASN may be adapted to fan out several R4 messages and/or R6 messages from a single input R4 message and/or from a single input R6 message to several BS(s) of the target network or the target ASN.

According to another exemplary embodiment of the present invention, the message preparation device may be adapted to transmit a prepared message to an access service network gateway associated with the target network apparatus.

The target network apparatus may only accept messages from an ASN-GW or controller for the target network apparatus, therefore by adapting or preparing a message such, that the message may comprise the ASN-GW as the origin of the message may allow sending the message to the target network apparatus. The target network apparatus may be a T-BS, or a target ASN-GW.

According to another exemplary embodiment of the present invention, the target profile determining device may be adapted to store capability information and/or a profile information of the target network node.

Thus, during the uptime of a network apparatus may only once the profile of a target network apparatus have to be determined. Thus, time for determining the target network apparatus may be saved for future message submission or transmission.

According to another exemplary embodiment of the present invention, the message is at least one message of a handover message and of a radio resource management message.

A handover message may be a handover control message. An example of a handover control message may be specified by NWG (Network Group) specification of WMF (WiMAX™ Forum). Therefore, the trigger device may be adapted to detect as a trigger an initiation of a handover or of a RRM operation.

Being able to handle a HO message and/or an RRM message may also allow transferring these kinds of messages in heterogeneous networks basing on different profiles, in particular between networks basing on profile A and profile C.

According to another exemplary embodiment of the present invention, the message may be at least one message selected from the group of messages consisting of an R4 handover message, an R4 handover request message, an R6 handover message, an R6 handover request message, an R4 handover response message, an R4 handover acknowledge message, an R6 handover response message, an R6 handover acknowledge message. An R4/R6 handover message may be an R4 handover message and/or an R6 handover message. Furthermore, the message may be an R4/R6 pair-BS spare_capacity_request message, an R4/R6 pair BS spare_capacity_RPT message, an R4/R6 pair-BS radio config update request, an R4/R6 pair-BS radio config update report message and a radio config update acknowledge message.

According to another exemplary embodiment of the present invention, the target network apparatus is at least one apparatus selected from the group consisting of an access service network gateway, profile C access service network gateway profile C base station, and a profile A Base Station.

According to another exemplary embodiment of the present invention, the target network apparatus may be provided, wherein if the target network apparatus may be the Access Service Network Gateway, in particular the profile C Access Service Network Gateway and if the message may comprise more than one BS info values then the target network apparatus transmits the message indicating capability limitation

As an alternative if the target network apparatus is the profile C Access Service Network Gateway and the message origins from an Access Service Network of a different profile the target network apparatus may transmit the message indicating capability limitation.

According to another exemplary embodiment of the present invention if the target network apparatus may be the base station, e.g. a profile A base station and if the message may origin of a different Access Service Network Gateway than the Access Service Network Gateway associated with the base station then the target network apparatus may transmit the message indicating capability limitation.

As an alternative, if the target network apparatus may be the profile A base station and the message origins from a base station of a different profile then the target network apparatus transmits the message indicating capability limitation.

It has also to be noted that exemplary embodiments of the present invention and aspects of the invention have been described with reference to different subject-matters. In particular, some embodiments have been described with reference to apparatus type claims whereas other embodiments have been described with reference to method type claims. However, a person skilled in the art will gather from the above and the following description that unless other notified in addition to any combination between features belonging to one type of subject-matter also any combination between features relating to different subject-matters in particular between features of the apparatus claims and the features of the method claims may be considered to be disclosed with this application.

These and other aspects of the present invention will become apparent from and elucidated with reference to the embodiments described hereinafter.

Exemplary embodiments of the present invention will be described in the following with reference to the following drawings.

### BRIEF DESCRIPTION OF THE DRAWINGS

FIG. 1 shows a block diagram of a network apparatus for transmitting a message to a target network apparatus according to an exemplary embodiment of the present invention.

FIG. 2 shows a block diagram of a target network apparatus for indicating capability limitation, according to an exemplary embodiment of the present invention.

FIG. 3 shows a block diagram of an interworking scenario of a network comprising an ASN based on profile A and an ASN based on profile C according to an exemplary embodiment of the present invention.

FIG. 4 shows a message flow diagram exchanging messages between an ASN based on profile A and an ASN based on profile C for a better understanding of the present invention.

FIG. 5 shows a message flow diagram sending a message from an ASN based on a profile C to an ASN based on profile A for a better understanding of the present invention.

FIG. 6 shows a message flow diagram for sending a message from a profile A ASN to a profile C ASN according to an exemplary embodiment of the present invention

FIG. 7 shows a message flow diagram for sending a message from a profile C ASN to a profile A ASN according to an exemplary embodiment of the present invention.

FIG. 8 shows a message flow diagram sending a message from a profile A ASN to a profile C ASN including detecting of the target ASN profile by receiving a failure indication according to an exemplary embodiment of the present invention.

FIG. 9 shows a message flow diagram for sending a message from a profile C ASN to a profile A ASN including detecting of the target ASN profile by receiving a failure indication according to an exemplary embodiment of the present invention.

FIG. 10 shows the message format of a hand over response message for transmitting an error indication according to an exemplary embodiment of the present invention.

### DETAILED DESCRIPTION

The illustration in the drawings is schematic. In different drawings, similar or identical elements are provided with the same reference numerals.

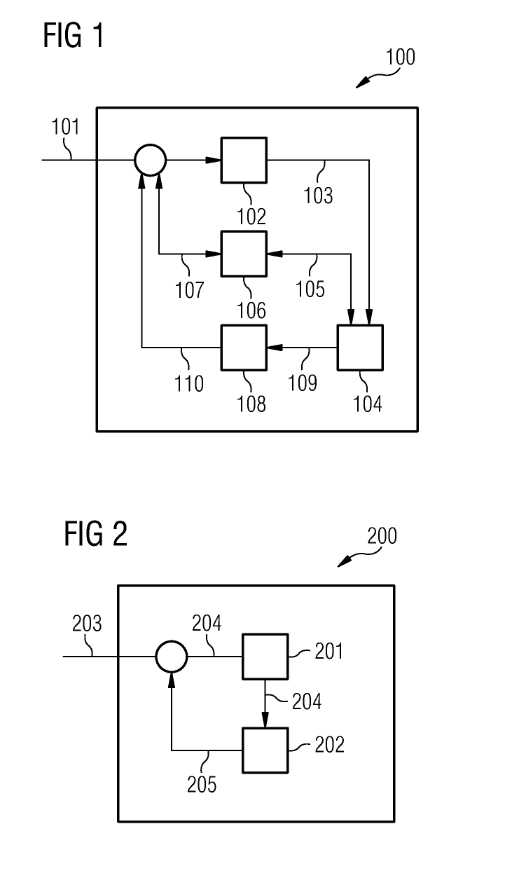

FIG. 1 shows a network apparatus according to an exemplary embodiment of the present invention. The network apparatus 100 may be an ASN-GW, a Base Station and in particular, the network apparatus 100 may be a profile A ASN, a profile C ASN-GW, an S-BS, a T-BS or a profile C Base Station. Via the connection line 101 the trigger device 102 receives a trigger indication, e.g. via a wire bound connection 101 or a wireless connection 101 to a corresponding network.

The trigger device 102 initiates the network apparatus 100 to transmit a message after receiving a trigger. A trigger may be a detection of the requirement that a corresponding MS may have to be handed over to another network or any other RRM operation.

After the trigger device 102, the handover trigger device 102 or the RRM trigger device 102 validly has detected a trigger condition the trigger device 102 uses the internal line 103 to inform the target message preparation device 104 to detect a profile of a target network apparatus.

Activity of the target network apparatus has been detected by the trigger device 102. The trigger device 102 informs via line 103 the message preparation device 104 about the activity of the target network device. The message preparation device 104 activates the target profile determining device 106. The internal connection 105 can be used by the message preparation device 104 to instruct the target profile determining device 106 to request, for example from the target network apparatus (not shown in FIG. 1), via lines 107 and 101 to determine the profile or the type of the profile of the target network apparatus. Lines 101 and 107 may be bidirectional lines.

After the message preparation device 104 has detected the profile, the message preparation device 104 compares the profile from the target network with the profile for the network apparatus 100. If the profile of the network apparatus 100 differs from the profile detected by the message preparation device 104, the message preparation device 104 prepares a message such, that the network apparatus of the first profile can communicate with the target network apparatus based on the profile of the target apparatus.

For example the message preparation device 104 may fan out multiple target BS info into single messages, if the network apparatus 100 bases on profile A and wants to communicate with a target network apparatus based on profile C.

In a case where the message preparation device 104 determines that the network apparatus 100 bases on profile C and a target network apparatus bases on profile A the network apparatus 100 may prepare a message such, that the message comprises as a source address or as a source identifier or as a source ID an address of a corresponding controller of the target network.

For example, in a case where the target network apparatus is a T-BS based on profile A the address of the corresponding T-ASN-GW, which bases on profile A may be inserted into a message which is sent to the T-BS.

The message preparation device 104 prepares the message such that the message-transmitting device 108, which receives the prepared message via link 109, only needs to transmit the message via lines 110 and 101.

In addition to that the target profile determining device 106 may be adapted to receive a message comprising different profile information and to transmit a corresponding failure indication to the sender of the corresponding message.

A network apparatus and a target network apparatus may be included in a single housing.

FIG. 2 shows a target network apparatus 200 comprising the receiving device 201 and the transmitting device 202. The receiving device 201 is adapted to receive a message via the connection 203, for example a wire bound network connection or a wireless network connection 203. The receiving device 201 is further adapted to detect that the received message has a different profile or indicates to origin from an ASN of a different profile than the target network apparatus 200.

A difference between a profile indicated by the received message and the profile expected by the target network apparatus 200 may be determined in several ways.

The target network apparatus 200 in the form of the target ASN GW or the target BS can realize detecting a difference in profiles when receiving a message from the serving ASN by assessing the content of the received message, e.g. the Src ID, Dst ID, and function type of the message, or by comparing the message format.

In detail, if a target ASN GW has received a HO message, such as HO_Req, and the destination ID Dst ID is the ASN GW ID, then the profile C ASN GW knows, the peer or sender misunderstood or doesn't know the ASN GW's profile.

On the other side, if multiple target BS info parameter are included in the HO_Req message, the profile C ASN GW knows, there is an error, because the profile C ASN GW cannot process the message with multiple BS info.

For target BS, e.g. a profile A BS, in case the target BS received a HO_Req message and the Src ID is not its HO function ID, i.e. the associated ASN GW ID, then the target BS knows that the peer misunderstood or does not know the profile of the target BS, then an error or a capability or a profile info is indicated to the peer.

In other words, determining a mismatch between the profile indicated by the received message and an expected profile of the target network apparatus 200, i.e. target ASN GW or target BS, makes the target network apparatus 200 to send an error indication, an error, a capability or a profile info indication to the peer or sending network apparatus.

After detecting the difference in the profile between the target network apparatus 200 and the profile information included in the received message the receiving device 201 instructs via link 204 the transmitting device to transmit a message which indicates that the network target device has capability limitations.

The knowledge about a profile can be used in inter-ASN scenarios. In other words, the profile info of the target network can useful to be known in the device in the serving network to quickly prepare a message. A profile info may not be used for a device in the same ASN (target network or serving network).

If the target network apparatus is located in an ASN having a different profile then the ASN in which the network apparatus is located, then the network apparatus and the target network apparatus may be used to communicate between the ASN networks basing on different profiles. Therefore, the network apparatus and the target network apparatus may be part of an inter-ASN scenario (heterogeneous environment).

In an intra-ASN scenario, i.e. the network apparatus and the target network apparatus may be located in the same ASN and basing on the same profiles (homogeneous environment). If the profile info is carried as an intra-ASN message, the network device of the same ASN will not analyse the message, it just relays the message.

Only the network device of different ASN (ASNs based on different profiles) analyse the message to acquire the profile of the peer ASN.

This message indicating capability limitations is sent via bidirectional link 205 and 203 to the originator of the message. In a particular example the message indicating that the target network apparatus 200 has capability limitations is an error indication, a failure indication or a handover request message, comprising error indication. Further messages, which may be reused to transport the error indication may be possible.

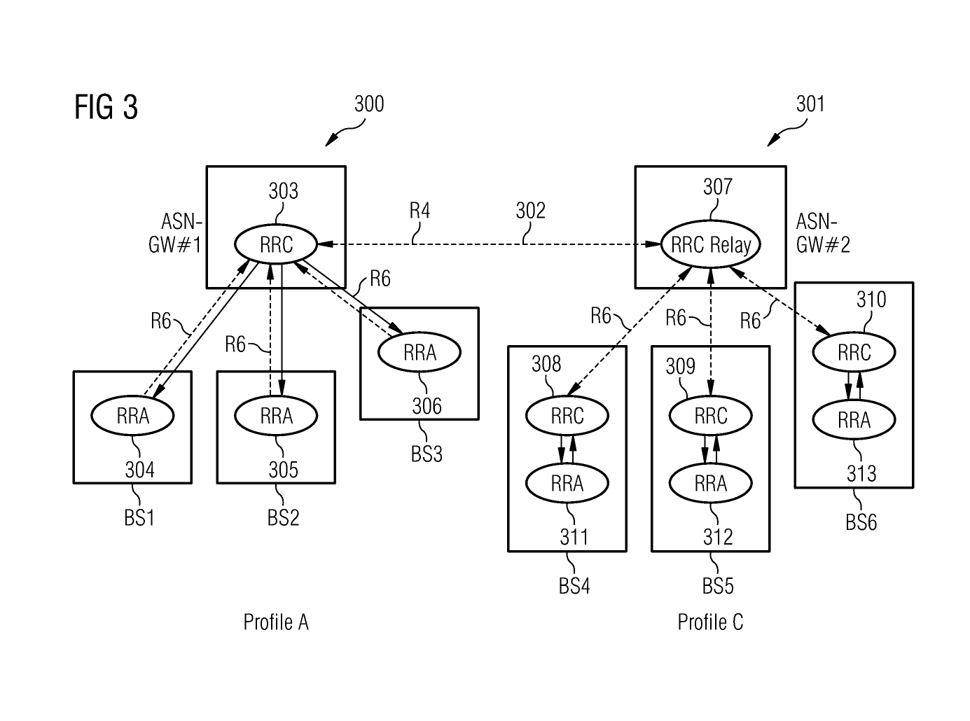

FIG. 3 shows a block diagram of a connection of an ASN1 300 and an ASN2 301 via an R4 link 302.

The ASN 300 bases on profile A. The ASN-GW#1 comprises the RRC 303. The RRC 303 links the ASN-GW#1 via R6 interfaces with Base Stations BS1, BS2, BS3. In particular the RRC 303 is linked to RRAs 304, 305, 306, which may be integrated into BS1, BS2, BS3. ASN-GW#1 and Base Stations BS1, BS2, BS3 base on profile A. Since Base Stations BS1, BS2, BS3 are connected with a central RRC 303 the ASN-GW#1 or controller can directly address each single Base Station BS1, BS2 and BS3. Therefore, a message which is received via link 302 and comprises multiple BS infos, may be fanned out to each single Base Station BS1, BS2, BS3 associated with the corresponding BS info.

Via the R4 link 302 the ASN-GW#1 is linked with ASN-GW#2, which bases on profile C. Thus ASN-GW#1 and ASN-GW#2 base on different profiles. The ASN-GW#2 comprises the RRC relay 307. The RRC relay 307 transparently switches a message received via R4 connection 302 via R6 connections to the Base Stations BS4, BS5, BS6. According to profile C the Base Stations BS4, BS5, BS6 each comprise the RRC 308, 309, 310 and the RRA 311, 312, 313.

RRC 307 may not be able to fan out messages included in a R4 message received via R4 connection 302. ASN-GW#1 may have a direct connection to ASN-GW#2 and therefore ASN-GW#1 may be the last component based on profile A of ASN 300.

ASN-GW#2 has a direct link to ASN-GW#1 and therefore ASN-GW#2 may be the last component of ASN 301, which bases on a profile C.

Therefore, in order to adapt a message sent to individual Base Stations in ASN 301 the ASN-GW#1 may be adapted to prepare a corresponding message, for example to fan out different messages comprised in a single message into single messages for the Base Stations BS4, BS5, BS6.

On the other side the ASN-GW#2 may adapt a message from ASN 301 directed to ASN 300 such, that the source ID of a corresponding message may be the source ID of the ASN-GW#1.

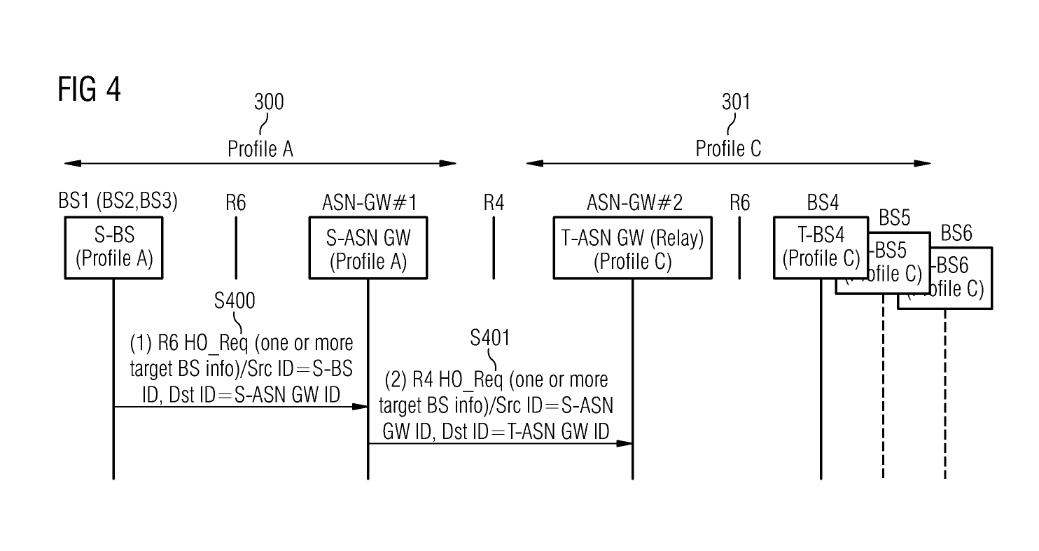

FIG. 4 shows a message flow diagram for sending a message from a profile A ASN 300 to a profile C ASN 301 for better understanding of the present invention. In the following as an example and as a message, which may be exchanged between first ASN 300 and a second ASN 301 may be a handover message. This is just to show the principles. And the use of any equivalent message such as a RRM message may be possible.

A handover (HO) may be detected from one of S-BS BS1, BS2, BS3. For example BS1 detects that a HO from profile A 300 to profile C 301 shall be conducted. The serving ASN-GW#1 receives in step S400 an R6 HO_Req message (handover request) comprising one or more target BS info, a source ID of S-BS ID for example BS1, and a destination ID which may be S-ASN-GW ID, e.g. the identification of ASN-GW#1.

The S-BS BS1 and the S-ASN-GW#1 base on profile A. ASN-GW#1 in step S401 generates a R4 HO_Req message comprising the one or more target BS info, for example a list of potential target BSs for a handover, a source ID of S-ASN-GW#1 and a destination identifier Dst ID of T-ASN-GW ID ASN-GW#2, which is a relay.

Thus, the serving ASN-GW#1 sends an R4 HO_Req to a target ASN-GW ASN-GW#2 without identifying the profile type of the peer ASN-GW, for example ASN-GW#2.

Before knowing the profile of the target ASN, the serving ASN-GW ASN-GW#1 just sends an R4 HO_Req message to the target ASN GW ASN-GW#2, since the serving ASN GW believes that the target has the same profile.

If however, the profile of target ASN is known inside the serving ASN, and it is different to the target profile, then the serving ASN GW sends separate R4 message to each target BS. Thus, the fact, that the target ASN GW is just a relay entity can be regarded.

However, if the peer ASN-GW or the target ASN GW ASN-GW#2 has the profile C, i.e. ASN-GW#2 is a relay, which may not know how to deal with the multiple BS info or the multiple BS info field included in the R4 HO_Req message received in step S401, the message may not be forwarded or may not be correctly forwarded.

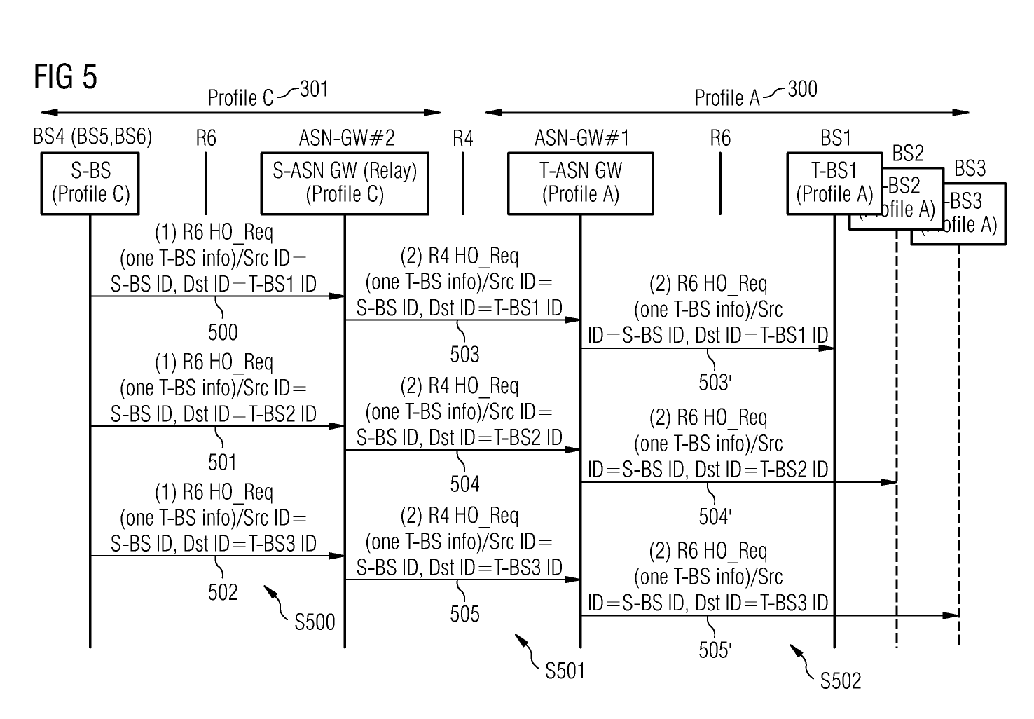

FIG. 5 shows a message flow diagram for signalling a handover from a profile C ASN to a profile A ASN without making an adaption to a message, for a better understanding of the present invention.

FIG. 5 shows what happens during handover from an MS connected to a profile C network to a profile A ASN. In step S500 the serving BS BS4, which base on profile C, sends an R6 handover request HO_Req to each selected target BS T-BS1, T-BS2, T-BS3. However, the S-BS BS4 sends the HO_Req message without identifying the profile type, i.e. a certain combination of parameter, of the target BS T-BS1, T-BS2, T-BS3, BS1, BS2, BS3. Therefore, in the example of FIG. 5 S-BS BS4 sends the three messages 500, 501 and 502. Message 500 is a R6 HO_Req message comprising one T-BS info or a single T-BS info, the source ID Src ID of S-BS ID BS4 and the destination ID Dst ID of T-BS1 BS1.

T-BS info is just a value, a parameter oder a TLV (Type, Length, Value) in a message. One T-BS info means one TLV included, more than one T-BS info means more than one similar parameters for different BSs are included in one R4/R6 message.

T-BS info thus is just a parameter of R4/R6 message, the parameter is coded in TLV mode, for example first bit indictes Type, second bit indicates Length, the third bit indicates Value.

A plurality of BS info may be a list of BS Info.

Furthermore, in step S500 the S-BS BS4 sends the R6 HO_Req message 501 comprising the one T-BS info, the Src ID set to S-BS ID BS4 and the destination ID Dst ID set to T-BS2 ID BS2.

Furthermore, the message 502 is a R6 HO_REQ message comprising one T-BS info, the Src ID set to the S-BS ID BS4 and the Dst ID set to the T-BS3 ID BS3.

The ASN GW ASN-GW#2 is just used as a relay entity if no direct R8 connection exists. Thus, since in the example of FIG. 5 no R8 connection exists, ASN-GW#2 is used as a relay. Therefore, in step S501 the messages of S500 are mapped into R4 HO_Req messages 503, 504, 505 having corresponding single T-BS info, and corresponding Dst IDs. Mapping the R6 HO_Req messages 500, 501, 502 into the R4 HO_Req messages 503, 504, 505 only leaves the Src ID unchanged to S-BS ID, e.g. BS4.

These three R4 HO_Req messages 503, 504, 505 reach the T-ASN GW ASN-GW#1 based on profile A, which in step S502 directs the R4 HO_Req messages 503, 504, 505 without amending to the corresponding T-BS BS1, BS2, BS3 as indicated with Dst ID. However, the target BS receiving the R6 HO_Req messages 503′, 504′, 505′ may not know what the R6 HO_Req message 503′, 504′, 505′ means having an Src ID of S-BS ID, which may be a different controller then the controller associated with BS1, Bs2, BS3, which may be ASN-GW#1.

Therefore, in order to enable interworking may adapting of the messages and of devices reacting to those messages be necessary.

In this text only HO and RRM messages and/or HO processes and RRM processes for profile A ASN and profile C ASN, respectively are described. But the ideas may also be applicable for other processes based on different profiles.

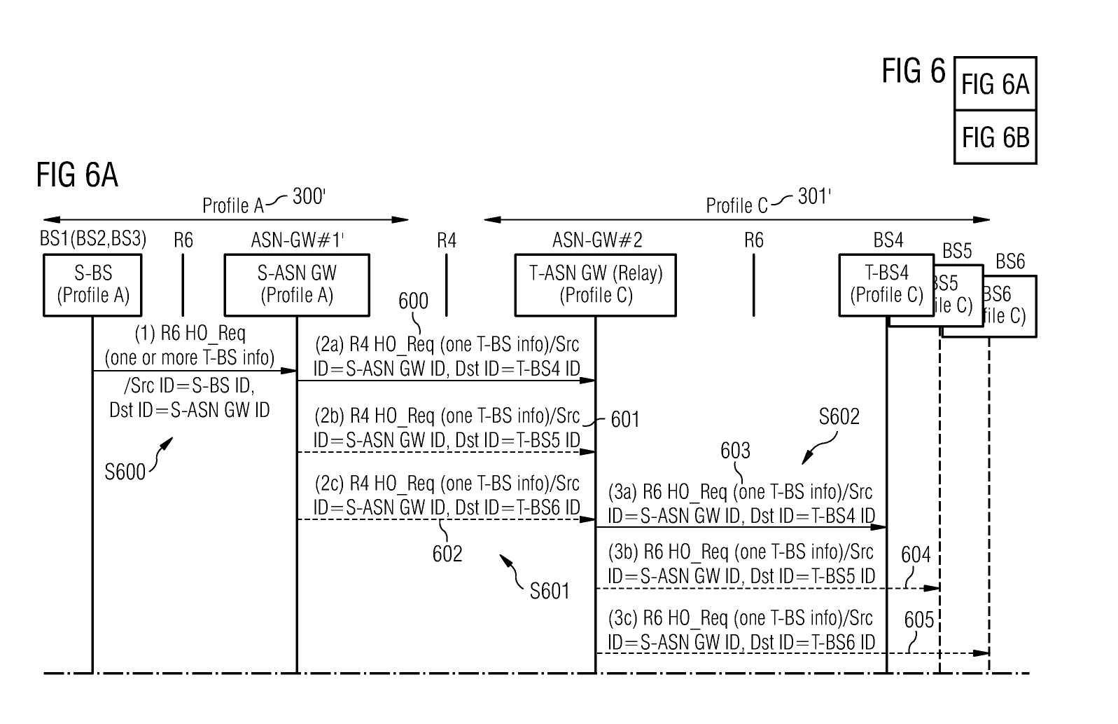

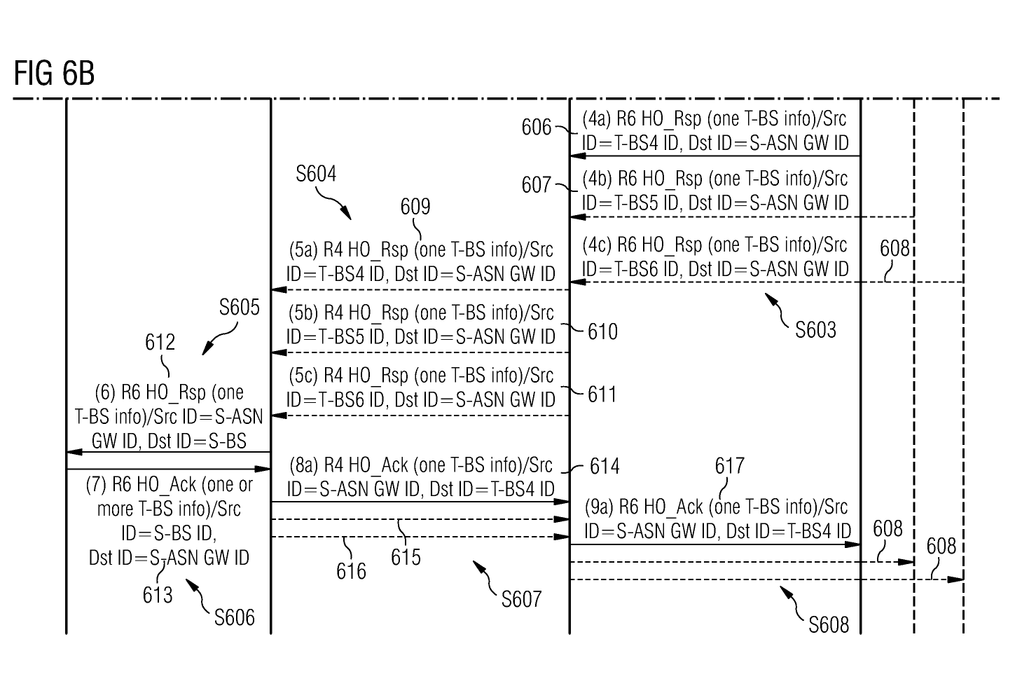

FIG. 6 shows a message-flow diagram for sending or transmitting a message from an ASN 300′ basing on profile A to an ASN 301′ basing on profile C. Thus, ASN 300′ and ASN 301′ have a different profile.

The process may be started when the S-BS receives MOB_MSHO-REQ from an MS (not shown in FIG. 6).

S-BS BS1 sends in step S600 the same R6 HO_Req message to ASN-GW#1′ as in step S400. Sending of R6 HO_Req message may be initiated by an MS intending to change from serving base station S-BS BS1 to at least one of the target base stations T-BS BS4, BS5, BS6.

To allow interworking between ASN of profile A ASN-GW#1′ and ASN of profile C ASN-GW#2, the profile A ASN-GW#1′ has been adapted to prepare corresponding messages for ASN 301′, in particular, for T-BSs BS4, BS5, BS6.

As shown in FIG. 6, the adapted ASN-GW#1′, detects that the information contained in R6 HO-Req message of S-BS BS1 has T-BS BS4, BS5, BS6 as target.

Receiving the R6 HO_Req message may be a trigger for transmitting a message to the T-BSs.

In step S601, upon receiving the R6 HO_Req message, the serving ASN GW ASN-GW#1′ analysis the message, determines the associated ASN GW ASN-GW#2 of target BS, which target BS is connected to the ASN GW by R6 interface. Then the serving ASN GW ASN-GW#1′ checks the profile type of the target ASN GW ASN-GW#2, which ASN GW ASN-GW#1′ may have learnt or preconfigured.

If the target ASN profile is profile C, then the serving ASN GW fans out a dedicated HO_Req message 600, 601, 602 to each target BS BS4, BS5, BS6. Furthermore, the destination ID (Identifier) Dst ID is set to the ID of target BS BS4, BS5, BS6.

Alternatively, the serving ASN GW ASN-GW#1′ checks the HO-Func location. The HO-Func location is indicated by HO-Func ID and/or target BS ID. The HO-Func location is associated with each target BS BS4, BS5, BS6. After checking or determining the HO-Func location, e.g. an IP address, the serving ASN GW ASN-GW#1′ fans out a dedicated R4 HO_Req to the location of the HO-func associated with each target BS.

If the target ASN is profile C, then the HO-func is located at the BS, i.e. the HO-func is collocated with the BS, i.e. the serving ASN GW fans out a dedicated R4 message to each target BS, the target ASN GW is just a relay.

In other words, in step S601 the S-ASN GW ASN-GW#1′ determines the type or the profile of the target ASN 301′ and in particular of the target ASN GW ASN-GW#2. In the scenario A as shown in FIG. 6 the ASN-GW#1′ determines that the target network or target ASN 301′ bases on profile C.

ASN-GW#1′ peers with ASN-GW#2. The profile type info of peer ASN GW ASN-GW#2, i.e. the profile on which target ASN GW ASN-GW#2 is based on, is reported to profile A ASN GW ASN-GW#1. ASN GW ASN-GW#1′ and ASN GW ASN-GW#2 are connected via an R4 interface.

For example, for detecting the profile of target ASN-GW#2, the profile A ASN GW ASN-GW#1′ uses the target profile determining device.

As an alternative way for detecting the profile of ASN-GW#2, the ASN-GW#1′ retrieves the HO-Func (Handover-Function) location info derived from profile type of target BSs, i.e. the BS associated with the target ASN GW. Thus, instead of reporting the profile on which the target ASN GW is based to the profile A ASN GW, the profile A ASN GW ASN-GW#1′ may receive the information of the HO-func location. With the knowledge of the location of the HO-func direct addressing may be possible.

In other words, there are at least two ways to know the HO-Function location of target ASN. Static configuration or dynamic learned through reusing of existing message or new messages.

If it is dynamically learned, then other connected network devices inform the network apparatus about the profile type or HO-Func location info. The information may be distributed using error indication messages for indicating capability limitation.

If the location of HO-func or the profile of neighbours is preconfigured in the network apparatus, then the network administrator informs the network apparatus about related info through certain configuration tools or command line.

Both HO-func location and profile type info can be stored locally in the network apparatus, e.g. in the ASN GW, for the convenience of checking

The HO-Func location may be the location where the HO control is conducted.

The HO-function location means BS ID or ASN GW ID depending on the profile type. Every device should know its own profile info or its own HO-func location and the corresponding info of other neighbour network devices, which info may be learned or configured in the network apparatus. This can be realized by configuration or by dynamically learning through distributing the profile or HO-func information using messages which may base on an existing message format or on a new message format.

For example, for profile A, the HO-func location or HO control is in ASN GW.

For example, for profile C, the HO-func location or HO control is in the base station (BS).

In an active scenario, active mechanisms are used for receiving the profile information about neighbour networks or network elements. Everytime when new information about a profile is received, this information is stored locally. This may allow before sending a message to quickly identify the profile of the target.

In a passive scenario, reactive mechanism is used. Thus, on request, i.e. when required, the profile information may be requested.

FIG. 6 shows an active scenario. Before sending out an R4 HO message, such as HO_Req, to target ASN ASN-GW#2 in step S601, the profile A ASN GW ASN-GW#1′ may identify the profile type of target ASN GW ASN-GW#2. In case of different profile types between the target ASN GW and the serving ASN GW, the profile A ASN GW fans out one dedicated R4 message 600, 601, 602 for each target BS BS4, BS5, BS6.

For example, if the “one or more T-BS info” field of the R6 HO-Req message sent in step S600 comprises a list of potential target BSs BS4, BS5, BS6 or candidates, a dedicated message for each of the target BS BS4, BS5, BS6 be generated within the S-ASN GW ASN-GW#1′.

For example, the first R4 HO_Req message 600 only comprise one T-BS info for BS4, the source identifier Src ID is S-ASN GW ASN-GW#1′ and the destination identifier Dst ID is T-BS4 ID BS4.

The HO_Req may comprise one T-BS or a single T-BS, i.e. a single TLV or a single parameter is included in one R4 message.

The second R4 HO_Req message 601 only comprise one T-BS info for BS5, the source identifier Src ID is S-ASN GW ASN-GW#1′ and the destination identifier Dst ID is T-BS5 ID BS5.

The third R4 HO_Req message 602 only comprise one T-BS info for BS6, the source identifier Src ID is S-ASN GW ASN-GW#1′ and the destination identifier Dst ID is T-BS6 ID BS6.

As an alternative way, based on the informed HO-func location info of neighbour BSs, the profile A ASN GW fans out a dedicated R4 HO message for each target BS.

In other words, the profile A ASN GW sends a R4 HO message to each target BS, the message is relayed by the target ASN GW to the target BS. The R4 message only includes one T-BS info, which is related to this target BS. Multiple target BS means, the profile A ASN GW sends several R4 message, each to one target BS.

In other words, the profile A ASN GW knows the location of the HO-function corresponding to the target BS.

The HO-function of the target BS may have been reported to the profile A ASN GW though static configuration or dynamical learning way.

From the location the profile A ASN GW may determine the profile of the target ASN GW. Thus, if a neighbour BS reports to the profile A ASN GW that the HO-function is located in the BS station itself, the profile A ASN GW knows that the BS is a profile C BS and therefore, the associated target ASN GW is also of type C.

Thus, the ASN-GW#1 can derive the information that in scenario A, showing a HO from profile A ASN to profile C ASN, ASN-GW#2 is a relay and the information about the individual T-BS, has to be extracted from the single R6 HO_Req message.

In step S602, the T-ASN GW ASN-GW#2 or the relay ASN-GW#2 generates R6 HO_Req messages 603, 604, 605 with the same content as the corresponding R4 messages 600, 601, 602, which have been fanned out, and ASN-GW#2 relays the R6 messages 603, 604, 605 to the corresponding target base station BS4, BS5, BS6. The messages 603, 604, 605 are substantially independently processed by the corresponding T-BS BS4, BS5, BS6.

Every single message 603, 604, 605 may be handled on the profile C side or in the profile C ASN 301′ as a common profile C message.

Thus, in step S603 the target BS(s) BS4, BS5, BS6 each send an R6 HO_Rsp message 606, 607, 608 to the Serving ASN GW to respond to the handover request.

Interworking of different profiles is described. The serving ASN may be based on profile A, where the HO function is located at the ASN GW, so the HO_Rsp should be sent to the S-ASN GW ASN-GW#1′.

The first R6 HO_Rsp message 606 comprises only one T-BS info. The source ID Src ID is set to T-BS4 ID of BS4 and the destination ID Dst ID is set to the S-ASN GW ID ASN-GW#1′, which has fanned out the messages.

The second R6 HO_Rsp message 607 comprises only on T-BS info. The source ID Src ID is set to T-BS5 ID of BS5 and the destination ID Dst ID is set to the S-ASN GW ID ASN-GW#1′.

The third R6 HO_Rsp message 608 comprises only on T-BS info. The source ID Src ID is set to T-BS6 ID of BS6 and the destination ID Dst ID is set to the S-ASN GW ID ASN-GW#1′.

In step S604, the T-ASN GW ASN-GW#2 maps the received R6 HO_Req messages to corresponding R4 HO_Rsp (Handover Response) messages 609, 610, 611.

Thus, the first R4 HO_Rsp message 609 comprises only one T-BS info, the Src ID set to T-BS4 ID BS4 and the Dst ID set to S-ASN GW ID ASN-GW#1′.

The second R4 HO_Rsp message 610 comprises only one T-BS info, the Src ID set to T-BS5 ID BS5 and the Dst ID set to S-ASN GW ID ASN-GW#1′.

The third R4 HO_Rsp message 611 comprises only one T-BS info, the Src ID set to T-BS6 ID BS6 and the Dst ID set to S-ASN GW ID ASN-GW#1′.

The ASN-GW#2 relays the generated R4 HO_Rsp messages 609, 610, 611 to the ASN-GW#1′.

In step S605, the A-ASN GW ASN-GW#1′ generates from the plurality of R4 HO_Rsp messages 609, 610, 611, the single R6 HO_Rsp message 612, which the ASN-GW#1′ sends to the S-BS BS1.

The three R4 messages in step S605 are packed into one single R6 message, e.g according to an existing message definition, and the R6 message 612 is sent to the S-BS BS1. It is possible that the three independent R4 messages 609, 610, 611 arrive at different times. So the serving ASN GW ASN-GW#1′ has to wait, either for all three R4 response messages, or just for the first one or for a plurality thereof. Before, packing the received messages 609, 610, 611 into a R6 response message some other conditions may have to be met.

The R6 HO_Rsp message 612 sent from ASN_GW#1′ to S-BS BS1 may also comprise only one T-BS info.

The Src ID is set to S-ASN GW ID ASN-GW#1′, i.e. the associated controller of S-BS BS1, in order to not disturb the S-BS BS1. Furthermore, the Dst ID is set to S-BS BS1.

In step S606, the S-BS BS1 generates as a response to the R6 HO_Rsp message an R6 HO_Ack message 613.

The R6 HO_Ack message, sent to the S-ASN GW ASN-GW#1′ comprises a plurality of T-BS info, i.e. one or more T-BS info, the Src ID is set to S-BS ID BS1 and the Dst ID is set to S-ASN GW ID ASN-GW#1.

For every one or more target BS info an Ack is sent in step S607.

In step S607, the A-ASN GW ASN-GW#1′ fans out the plurality of T-BS info of R6 HO Ack message 613 into corresponding R4 HO Ack messages 614, 615, 616. The serving ASN GW ASN-GW#1′ conducts a similar process as in step S601 and the ASN GW ASN-GW#1′ sends out a dedicated HO Ack message 614, 615, 616 to each target BS BS4, BS5, BS6.

The target ASN GW ASN-GW#2 in step S608, generates corresponding R6 HO_Ack messages 617, 618, 619 and relays the messages 617, 618, 619 to the corresponding T-BS BS4, BS5, BS6 indicated by the Dst ID. This terminates the process.

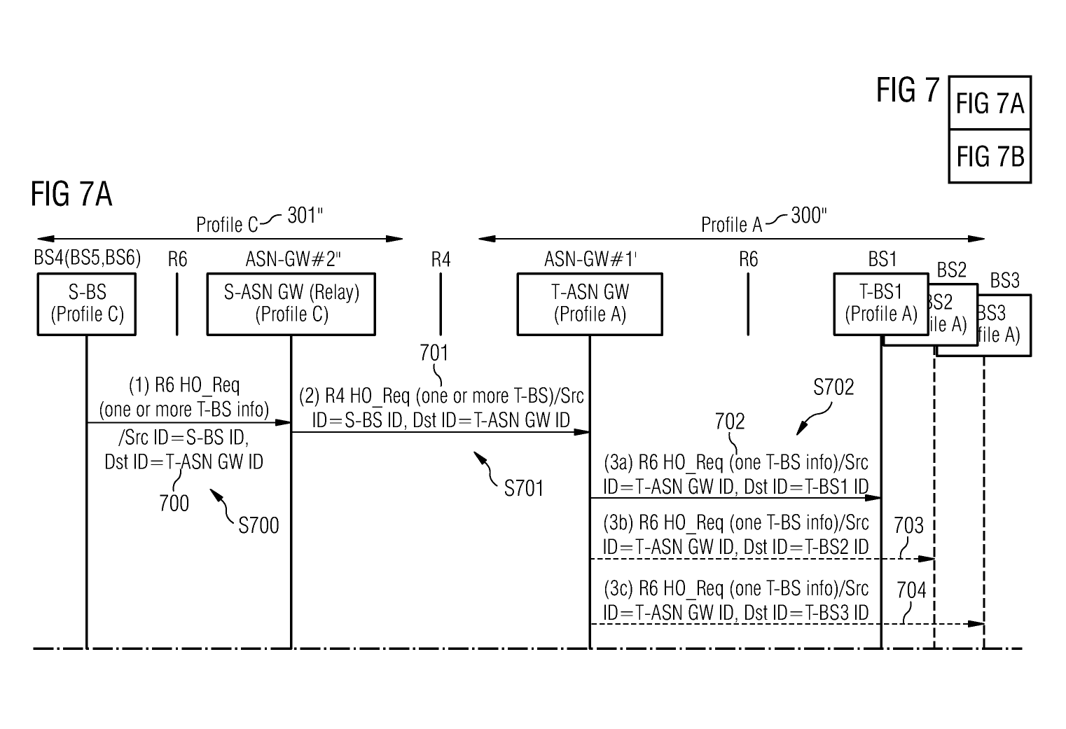

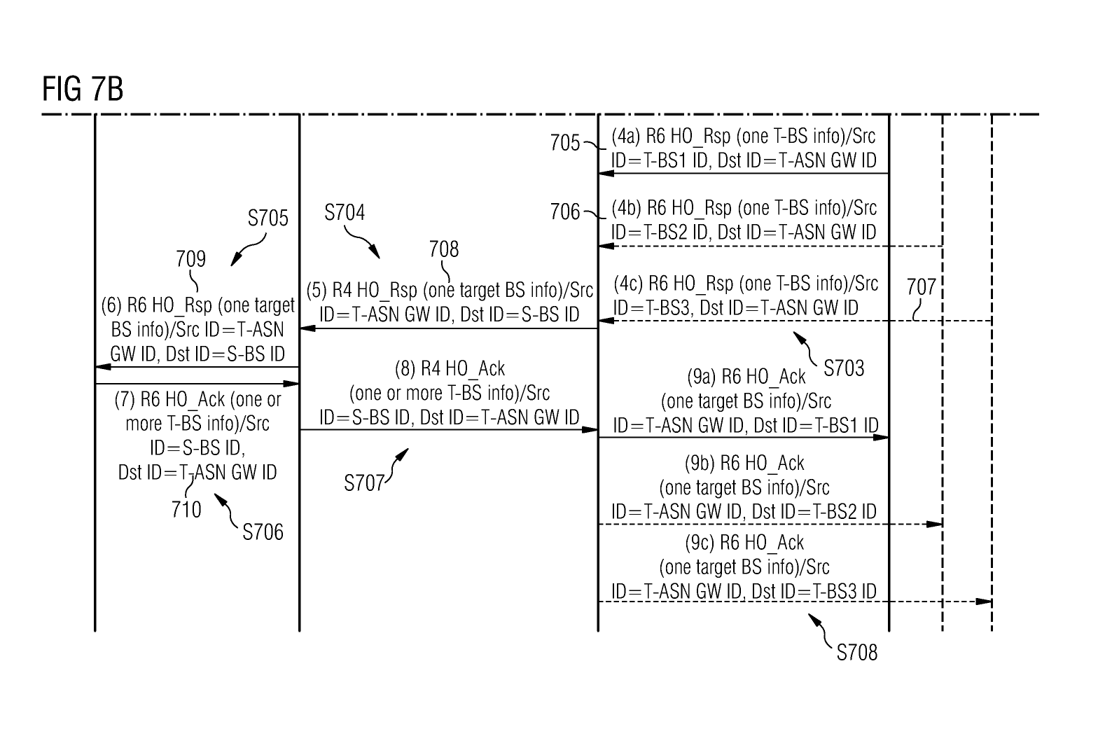

FIG. 7 shows a scenario for a handover (HO) from a profile C ASN to a profile A ASN.

FIG. 7 shows as FIG. 6 an active mechanism for determining the profile since the profile type is actively detected on sender side. I.e. the sender, e.g. the S-BS or the S-ASN GW determine the profile type of a T-BS and a T-ASN GW, respectively.

The profile type info of neighbor BSs and their associated ASN GW are reported to the profile C BS.

As an alternative way, the HO-func location derived from profile type of related neighbor BSs is informed to the profile C BS.

Potential target BSs are neighbour BSs of the serving BS. Thus, for example, if one MS hands-over from one serving BS to another target BS, the other target BS is a neighbour. At the time before a HO may happen, several candidates for becoming the target BS may exist. All these potential target BSs are the neighbours of the serving BS.

BS4, BS5, BS6 as well as ASN-GW#2″ base on profile C. In step S700, before the S-BS BS4, BS5, BS6 sends an R6 HO_Req message, the S-BS BS4 checks the profile type of target BS BS1, BS2, BS3. If the checked or detected profile type of the target BS BS4, BS5, BS6 is profile A, the S-BS BS4, BS5, BS6 sends the R6 HO_Req message to the target ASN GW ASN-GW#1. The S-BS B4, B5, B6 may be connected to ASN-GW#1 via R6.

If multiple target BSs BS1, BS2, BS3 are associated with one single ASN GW T-ASN GW, then multiple BS info may be included in the R6 HO_Req message.

In other words, before sending out R6 HO messages 700, such as the HO_Req message 700, to target ASN ASN-GW#1, the profile C BS or S-BS BS4, BS5, BS6 actively identifies the profile type of the target BSs BS1, BS2, BS3, in case of different profile types have been identified, the profile C BS BS4, BS5, BS6 sends the HO message to the ASN GW ASN-GW#1 associated with the neighbour BS BS1, BS2, BS3 and not to the neighbor BS BS1, BS2, BS3 directly.

If the S-BS identifies a target BS of the same type, the S-BS can directly send the HO message or RRM message to the target BS.

Alternatively, the S-BS BS4, BS5, BS6 checks the HO-func location indicated by HO-func ID and/or indicated by ASN GW ID. An example of the GW ID is the IP address of the GW (Gateway).

The HO-func is associated with the neighbour BS. If the HO-func of multiple target BSs is same, then multiple BS info maybe included in the R6 HO_Req message to the target ASN GW.

In other words, if these multiple BSs have the same HO-func or the HO-func is located at the same target ASN GW, the S-BS sends a R6 message to the target ASN GW ASN-GW#1, the serving ASN GW ASN-GW#2″ is just a relay entity.

In other words, as an alternative way, based on the informed HO-func location of neighbour BSs, the profile C BS BS4, BS5, BS6 sends a HO message to the ASN GW ASN-GW#1 associated with neighbour BS BS1, BS2, BS3.

The R6 HO_Req message 700 comprise one or more T-BS info, Src ID set to S-BS ID BS4.

In step S701 the ASN GW ASN-GW#2″ relays the HO_Req to the target ASN ASN-GW#1. An R4 HO_Req message 701 is generated comprising, one or more T-BS info, a Src ID set to S-BS ID BS4 and a Dst ID set to T-ASN GW ID ASN GW#1.

In step S702, the target ASN ASN-GW#1 may fan out a separate R6 HO_Req message 702, 703, 704 to each T-BS respectively if multiple target BS info is included the R4 HO_Req message.

The first R6 HO_Req message 702 comprises only one T-BS info, the Src ID set to T-ASN GW ID ASN GW#1 and Dst ID set to the T-BS1.

The second R6 HO_Req message 703 comprises only one T-BS info, the Src ID set to T-ASN GW ID ASN GW#1 and Dst ID set to the T-BS2.

The third R6 HO_Req message 704 comprises only one T-BS info, the Src ID set to T-ASN GW ID ASN GW#1 and Dst ID set to the T-BS3.

In step S703 the HO_Rsp messages 705, 706, 707 are generated by the T-BSs and sent to the T-ASN GW.

The first R6 HO Rsp message 705 comprises only one T-BS info, the Src ID is set to T-BS1 ID BS1 and the Dst ID is set to the T-ASN GW ID ASN-GW#1.

The second R6 HO Rsp message 706 comprises only one T-BS info, the Src ID is set to T-BS2 ID BS2 and the Dst ID is set to the T-ASN GW ID ASN-GW#1.

The third R6 HO Rsp message 707 comprises only one T-BS info, the Src ID is set to T-BS3 ID BS3 and the Dst ID is set to the T-ASN GW ID ASN-GW#1.

The T-ASN GW in step S704 generates the single R4 HO_Rsp message 708, comprising only one target BS info, the Src ID set to T-ASN GW ID and the Dst ID set to S-BS ID.

This R4 HO_Rsp is sent to the ASN GW relay ASN-GW#2″.

The ASN GW or S-ASN GW (serving ASN GW) in step S705 generates the R6 HO_Rsp message 709, which is transmitted to the S-BS BS4, BS5, BS6. The R6 HO RSP message 709 comprises the only one target BS info, the Src ID set to the T-ASN GW ASN-GW#1.

In step S706, the S-BS BS4, BS5, BS6 completes the similar process as specified in steps S700, S701 and S702, wherein R4/R6 HO_Acks messages are generated and sent to the corresponding T-BS BS1, BS2, BS3.

The steps S707 and S708 are similar to steps S701 and S702.

FIGS. 6 and 7 show active mechanism to explore the profile of a target ASN 301′, 300″ and in particular of T-ASN GW ASN-GW#2 and/or of the T-BS BS1, BS2, BS3.

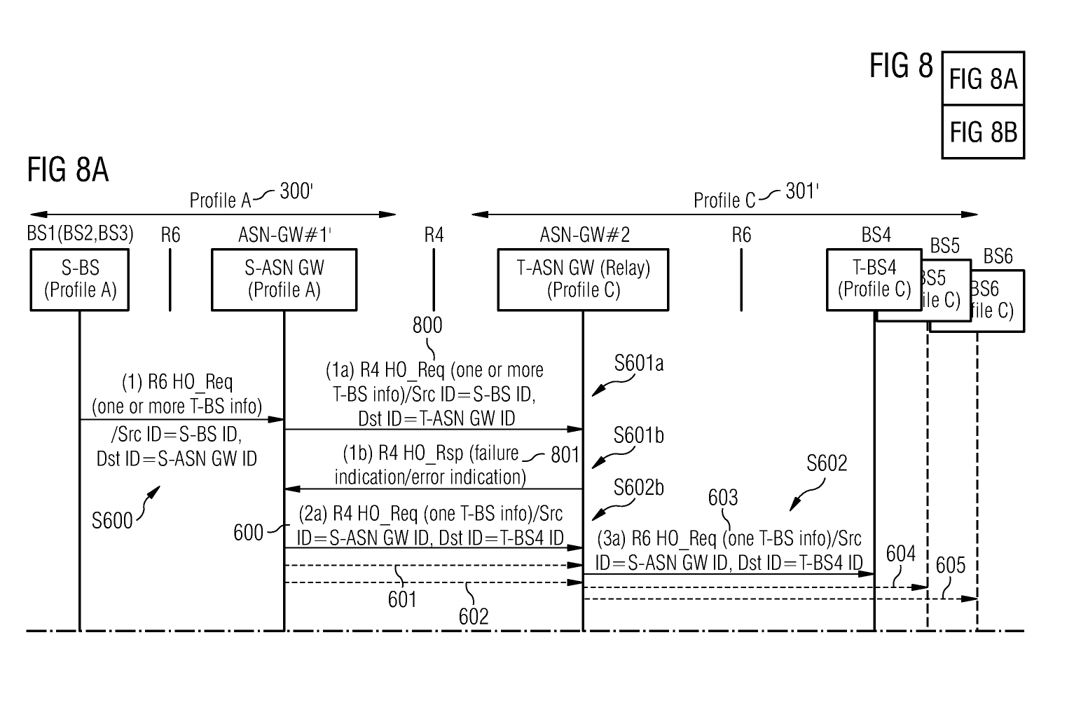

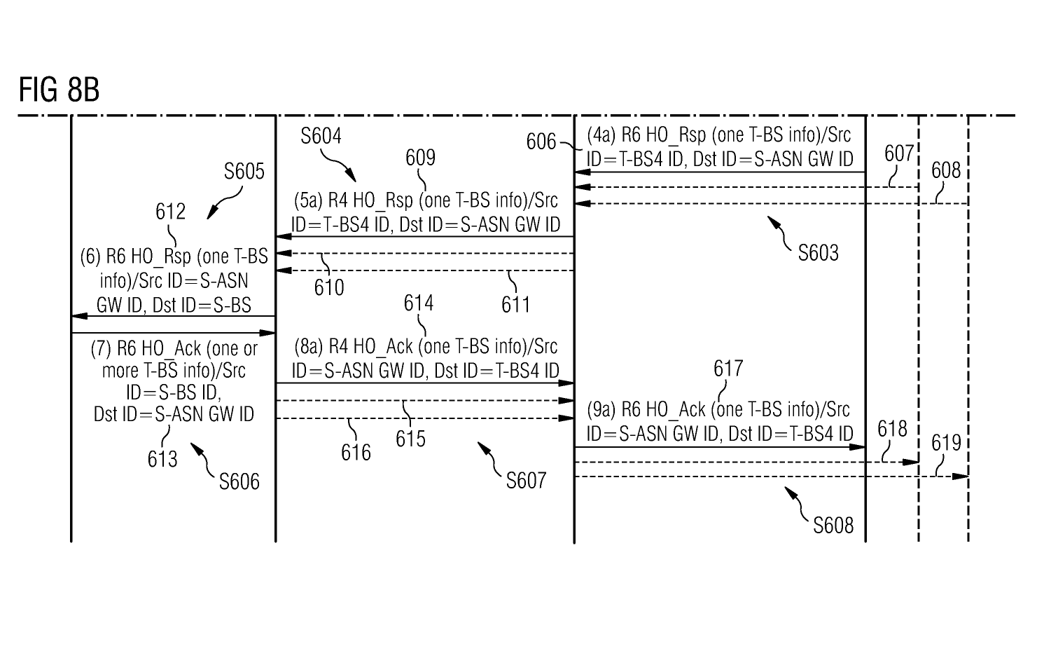

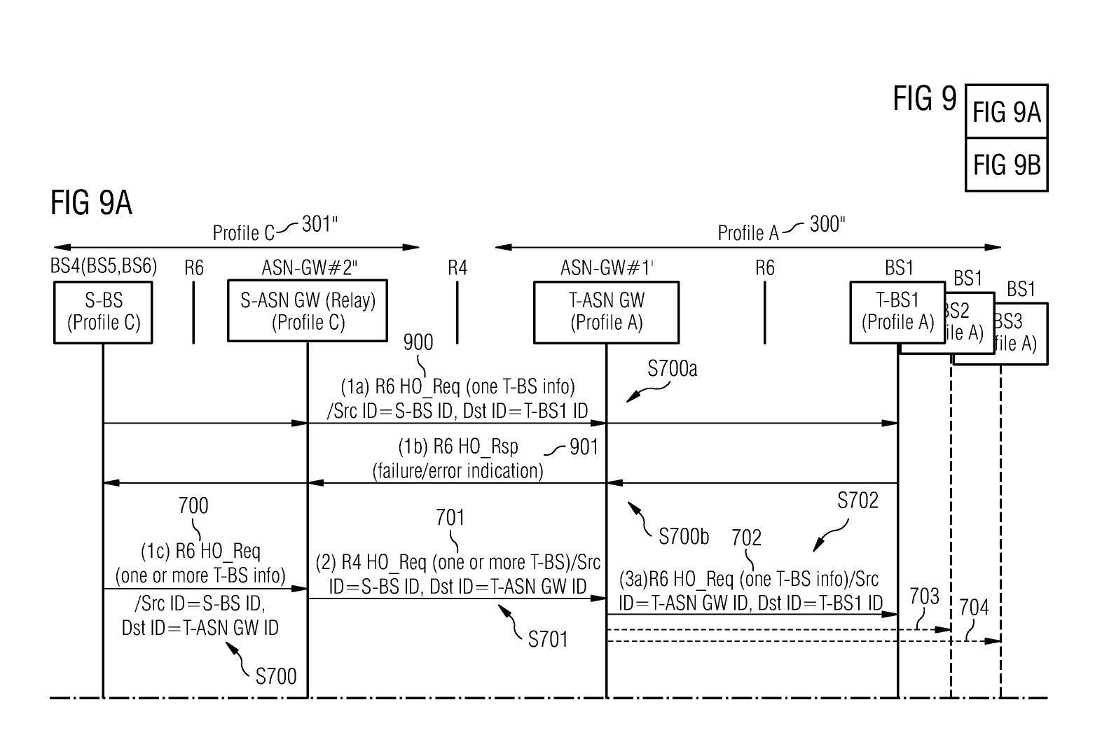

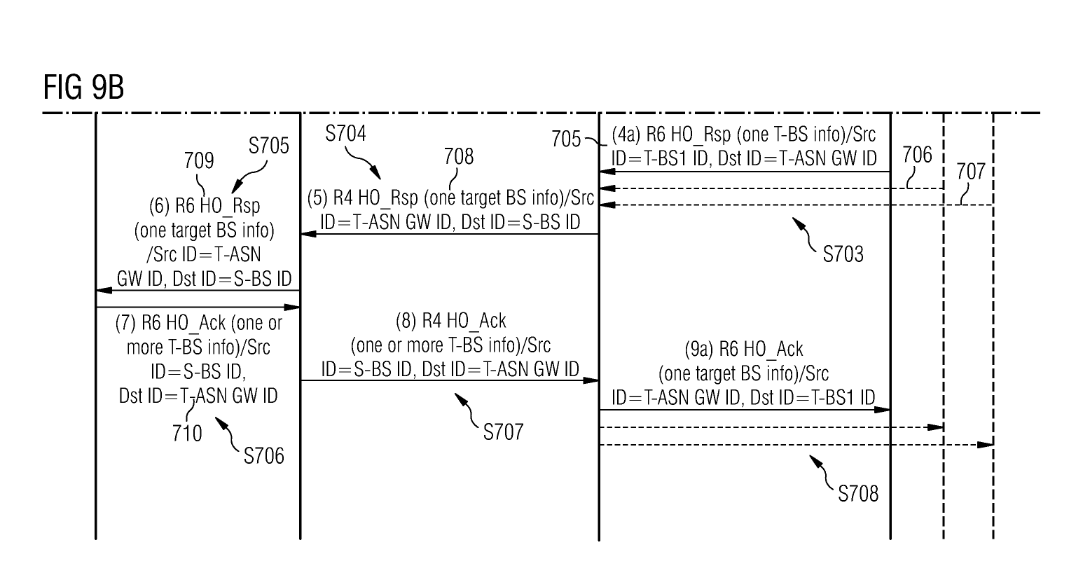

FIGS. 8 and 9 show reactive mechanism to identify or to explore the profile of a target ASN 301′, 300″ and in particular of T-ASN GW ASN-GW#2 and /or of the T-BS BS1, BS2, BS3. The profile is identified on request before sending a message without actively identifying the profile of a target ASN 301′, 300″ and in particular of T-ASN GW ASN-GW#2 and/or of the T-BS BS1, BS2, BS3. Thus, no active mechanism may be deployed such as storing profile information of neighbours in a storage.

FIG. 8 shows a HO scenario from profile A ASN 300′ to profile C ASN 301′ as in FIG. 6. Therefore, steps S600, S602, S603, S604, S605, S606, S607, S608 and S609 are identical as to those as described in FIG. 6.

However, since the target profile is not known or stored in the ASN-GW#1, in step 601a a profile A ASN GW ASNGW#1′ sends an R4 HO message, such as HO_Req, with one or more BS info to the profile C ASN GW ASN-GW#2 without differentiating the profile type, i.e. without fanning out or extracting the one or more BS info in single messages as in step S601 of FIG. 6.

Thus, the message is sent, and the profile info is included in the message 801 as a parameter to indicate the profile. In other words, by receiving a not applicable combination of parameters in the R4 HO_Req message, ASN-GW#2 detects, that the sender may not know the profile of T-ASN GW ASN-GW#2.

The R4 HO_Req message 800 comprises one or more T-BS info, a Src ID set to the S-BS ID BS1 and a Dst ID set to T-ASN GW ID ASN-GW#2.

In other words, in step S601a the serving ASN GW ASN-GW#1′ sends a R4 HO_Req message 800 with one or more multiple target BS info to the serving ASN GW ASN-GW#2 without differentiating the profile type of peer ASN ASN-GW#2.

In step S601b, the profile C ASN GW ASN-GW#2 replies with an appropriate message 801 to indicate the ASN-GW#2 is not equipped to process the message 800 due to capability limitation. The message 801 may also comprise profile informations of ASN-GW#2.

For example, the HO_Rsp message 801 is reused for the purpose, but other message format may be implemented. The HO Rsp message 801 comprises a failure indication and/or an error indication.

In Step S602a, upon receiving the response message 801, the serving ASN GW ASN-GW#1′ knows the capability of peer ASN GW ASN-GW#2 and stores the info for future use, then serving ASN GW ASN-GW#1′ sends a dedicated R4 HO_Req message 600, 601, 602 to each target BS BS4, BS5, BS6 separately.

In other words, the inactive mechanism or reactive mechanism of FIG. 8 comprises upon receiving the response message 801 with appropriate failure/error indication, the profile A ASN GW ASN-GW#1′ sends a dedicated R4 HO message 600, 601, 602 to each target BS BS4, BS5, BS6 separately according to the included target BS info. Furthermore, the profile A ASN GW stores the capability info derived from the response message 801 for future use. The capability information may be included in the error indication.

Other steps are same as those for scenario A of FIG. 6.

When the T-ASN GW ASN-GW#2 in the target ASN 301′ of profile C receives S601a a HO message 800 from the serving ASN ASN-GW#1′, the ASN-GW#2 response with an appropriate message 801 to indicate the profile type of the T-ASN ASN-GW#2 or with the capability limitation of the T-ASN ASN-GW#2 to process a HO message.

When the S-ASN GW ASN-GW#1′ in the serving ASN 300′ of profile A receives S601b the appropriate response message 801 from ASN-GW#2, the S-ASN GW ASN-GW#1′ stores the profile or capability information of the target ASN ASN-GW#2 for a later use.

The ASN GW ASN-GW#1′ of profile A in the serving ASN sends a R4 HO message S602a to the target ASN according to the stored capability of profile information learned respectively stored before.

If the profile information is not stored, the ASN GW ASN-GW#1′ sends the R4 HO message 800 to T-ASN GW ASN-GW#2.

FIG. 9 shows a HO scenario from profile C ASN 301″ to profile A ASN 300″ as in FIG. 7. Therefore, steps S700, S701, S702, S703, S704, S705, S706, S708 are identical to those as described in FIG. 7.

In addition to FIG. 7, since S-BS BS4 has no knowledge about the profile of T-BSs BS1, BS2, BS3, in step S700a the serving BS BS4 sends a R6 HO_Req message 900 to a target BS BS1, BS2, BS3 without differentiating its profile type.

A S-BS may not differentiate the profile of target ASN. In other words, whether the peer is profile A or C, or B, the same action is performed.

The correct behaviour should be reached by taking different action according to the different profile of target ASN or target BS.

In other words, initially a network apparatus may not have profile information about neighbours. However by communicating with other network equipment the network apparatus dynamically learns about profiles of the neighbours. Thus, if the network apparatus may communicate one with another the network apparatus may use stored information, learned information or configured information.

Taking the profile into account may be necessary for inter-ASN communication or interworking of different ASN basing on different profiles.

The R6 HO Req message 900 comprises one T-BS info, the Src ID is set to S-BS ID BS4 and the Dst ID is set to T-BS1 ID BS1. Thus, the profile C BS BS4 sends a R6/R8 HO message 900, such as HO_Req, to a target BS BS1, BS2, BS3 directly, without differentiating the profile type.

In step S700b, the target BS BS1, BS2, BS3, which is adapted to generate the error indication 901, replies with an appropriate message 901 to indicate that the target BS BS1, BS2, BS3 cannot process the message due to capability limitation.

In other words, the target BS BS1, BS2, BS3 replies with an appropriate message 901 to indicate that the target BS BS1, BS2, BS3 cannot process the message because the message comes from other ASN.

For the reply message 901, the HO_Rsp message is reused but other message formats may also be possible.

The R6 HO_Rsp message 901 comprises a failure indication and/or an error indication.

Thus, when the T-BS BS1, BS2, BS3 in the target ASN 300″ of profile A receives a HO message 900 from the serving BS BS4, BS5, BS6 the T-BS BS1, Bs2, BS3 responses with the appropriate message 901 to indicate the profile type of T-BS BS1, BS2, BS3 or the capability limitation to process the HO message 900.

When the S-BS BS4, BS5, BS6 of profile C in the serving ASN 301″ receives the appropriate response message 901, the S-BS BS4, BS5, BS6 stores the profile information or the capability info of target ASN 300″ for a later use.

The S-BS of profile C in the serving ASN 301″ sends an R4 HO message to the target ASN 300″ according to the stored capability of the profile information learned before.

In a case that no stored information exists the S-BS of profile C sends the HO message 900 to T-BS BS1, BS2, BS3.

Generally the same principles as described for HO messages also apply for RRM messages.

In step S700, upon receiving the response message 901, the serving BS BS4, BS5, BS6 knows the capability of the target BS BS1, BS2, Bs3 and stores the info for future use.

Then the serving BS BS4, BS5, BS6 sends a dedicated R6 HO_Req 700 message to the target ASN GW ASN-GW#1 associated with the target BS BS1, Bs2, BS3. The associated target ASN GW ASN-GW#1 has a R6 connection with the target BS BS1, BS2, Bs3.

In case more than one target BSs BS1, BS2, Bs3 are associated with a common target ASN GW ASN-GW#1, then more than one target BS info can be included in the R6 HO_Req message.

The reactive method can be statically configured or can be a dynamic learning method.

The profile or HO-function info can be stored in S-BS by statically configuration or dynamically learning method.

The reactive method means no profile or HO function info is reported to the network apparatus and thus, the network apparatus may just try communicating in a default way. If error or profile is reported, then the network apparatus takes correct action according to the reported info.

HO-func may mean the HO control instead of HO relay function.

An active mechanism as described in FIGS. 6 and 7 can be used to avoid occurring of interworking problems between profile C ASN and profile A ASN.

A reactive mechanism as described in FIGS. 8 and 9 can react to detected interworking incompatibilities between different profiles.

Existing HO or RRM protocols may substantially not need to be adapted. Thus, it may be backward compatible.

The stateless of profile C ASN GW during Inter-ASN HO of different profile type can be kept.

The described methods may be simply and easily to implemented.

A protocol analyzer may help detecting the employment of one of the methods.

The methods may also be implemented in a so called WiMAX@Home Architecture.

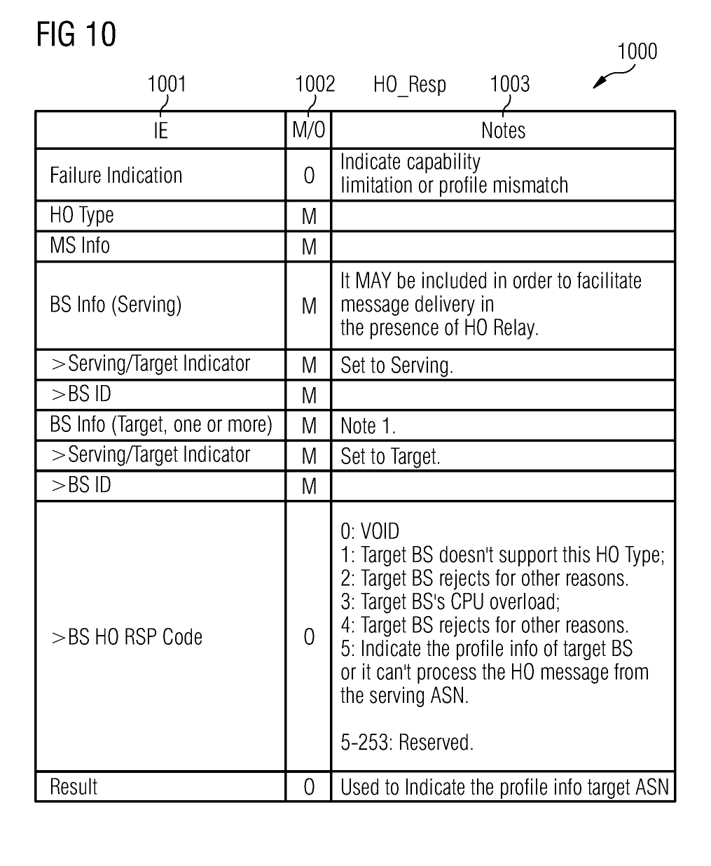

FIG. 10 shows message format of a hand over response message for transmitting an error indication according to an exemplary embodiment of the present invention.

No special message format may be needed, existing parameter may be reused, some other values may have to be defined to indicate the profile info or capability limitation.

The HO_Rsp message comprises only the information elements (IE) 1001. In the message format presentation of FIG. 10 in addition to the IE 1001, flags are shown indicating whether an information element 1001 is mandatory (M) or optional (O). The flags are shown as a first column 1002 next to the IEs 1001. In a second column 1003 comments relating the corresponding IE are provided.

Other formats of a message transmitting error indications may be possible.

The HO_Rsp message comprises the IEs Failure Indication, HO Type, MS Info, BS Info (Serving), BS info (Target, one or more) and Result Code.

The Failure Indication is an optional IE which indicates capability limitation, profile info or profile mismatch.

The HO Type is a mandatory IE.

The MS Info is a mandatory IE.

The BS Info (Serving) is a mandatory IE which may be included in order to facilitate message delivery in the presence of HO Relay.

The BS Info (Serving) IE comprises the mandatory parameter Serving/Target indicator which may generally be set to Serving.

The BS Info (Serving) IE comprises the mandatory parameter BS ID (Base Station Identifier).

The BS Info (Target, one or more) is a mandatory IE.

The BS info IE comprises the parameter Serving/Target Indicator, which is a mandatory parameter and generally set to the value Target.

The BS info IE comprises the BS ID, which is a mandatory parameter.

Furthermore, the BS Info comprises the BS HO RSP code, which is an optional parameter. The BS HO RSP Code may be set to different values. The value 0 may mean void. The value 1 may mean that the target BS does not support this HO Type. The value 2 may mean that the target BS rejects for other reasons. The value 3 may mean that the target's CPU overload. The value 4 may mean that the target BS rejects for other reasons.

The value 5 indicates the profile info or profile information of the target BS. Furthermore, the BS HO RSP Code set to the value 5 can alternatively indicate that the target BS cannot process the HO message from the serving ASN.

The values 5-255 or 6-255 are reserved.

The optional IE Result Code can be used to indicate the profile information of a target ASN.

A network apparatus receiving a HO_Rsp thus may store the Result Code provided with the HO_Rsp message.

In order to communicate error indications, may only a selection of parameters from the HO_Rsp message may be used. The selection may comprise the IEs and/or parameters failure indication, BS HO RSP Code and the result code.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### ACRONYMS AND TERMINOLOGY

ASN Access Service Network

BS Base Station

HO Handoff

HO-Func Handover Function

S-BS Serving Base Station

T-BS Target Base Station

1. A network apparatus for transmitting a message to a target network apparatus, comprising:
a trigger device;
a target profile determining device;
a message preparation device; and
a message transmitting device;
wherein the trigger device is adapted for determining a trigger for transmitting the message;
wherein the target profile determining device is adapted for determining a profile of the target network apparatus;
wherein the message preparation device is adapted for preparing a message for transmitting the message to the target network apparatus in accordance with the determined profile of the target network apparatus; and
wherein the transmitting device is adapted for transmitting the prepared message.

2. The network apparatus of claim 1, wherein determining the profile of the target network apparatus comprises at least one of the following:
retrieving information about the target profile stored in the target profile determining device; and
retrieving information about the target profile by transmitting a message in accordance with the profile of the network apparatus.

3. The network apparatus of claim 1, wherein the message preparation device is adapted for determining the destination for the prepared message by deriving a Handover Function location (HO Func location).

4. The network apparatus of one of claim 1, wherein the message comprises a multiple target BS value.

5. The network apparatus of claim 1, wherein the network apparatus is at least one network apparatus selected from the group consisting of
an Access Service Network Gateway,
a profile A Access Service Network Gateway,
a profile C Access Service Network Gateway,
a base station,
a serving base station,
a target base station, and
a profile C Bases Station.

6. The network apparatus of claim 1 wherein the profile determining device is adapted to determine the profile of the target network by at least one method selected from the group of methods consisting of
receiving the profile from the target network apparatus;
receiving the profile from a central server;
receiving the profile from static configuration; receiving the profile from dynamically learning;
receiving a Handover function location derived from a profile type from a static configuration; and
receiving a capability limitation message from the target network apparatus.

7. The network apparatus of claim 4, wherein the message preparation device is adapted to fan out a message to the target network apparatus.

8. The network apparatus of claim 1 wherein the message preparation device is adapted to transmit the prepared message to an Access Service Network Gateway associated with the target network apparatus.

9. The network apparatus of claim 1, wherein the target profile determining device is adapted to store capability information and/or profile information of the target network node.

10. The network apparatus of claim 1, wherein the message is at least one message of
a handover message and
a radio resource management message.

11. The network of claim 1, wherein the message is at least one message selected from the group consisting of:
an R4 handover message;
an R4 handover request message;
an R6 handover message;
an R6 handover request message;
an R4 handover response message;
an R4 handover acknowledge message;
an R6 handover response message; and
an R6 handover acknowledge message.

12. A target network apparatus for indicating capability limitation, comprising:
a receiving device;
a transmitting device;
wherein the receiving device is adapted for receiving a message and for detecting an associated profile necessary for handling the message;
wherein the transmitting device is adapted for transmitting a message indicating capability limitation if the target network bases on a profile different from the profile necessary for handling the received message.

13. The target network apparatus of claim 12, wherein the target network apparatus is at least one apparatus selected from the group consisting of
an Access Service Network Gateway,
a profile C Access Service Network Gateway,
a base station,
a profile A base station; and
a profile C base station.

14. The target network apparatus of claim 13, wherein
if the target network apparatus is the Access Service Network Gateway; and
the message comprises more than one BS info values;
or
if the target network apparatus is the Access Service Network Gateway; and
the message origins from an Access Service Network of a different profile;
the target network apparatus transmits the message indicating capability limitation.

15. The target network apparatus of claim 14, wherein
if the target network apparatus is the base station; and
the message origins from a different Access Service Network Gateway than the Network Access Gateway associated with the base station;
or
if the target network apparatus is the profile A base station; and
the message origins from a base station of a different profile;
the target network apparatus transmits the message indicating capability limitation.

16. The target network apparatus of claim 12, wherein the message indicating capability limitation is a message indicating the profile of the target network apparatus.

17. A method for transmitting a message to a target network apparatus comprising:
determining a trigger for transmitting the message;
determining a profile of the target network apparatus;
preparing a message for transmitting the message to the target network apparatus in accordance with the determined profile of the target network apparatus; and
transmitting the prepared message.

18-20. (canceled)
